(19) United States
(12) Patent Application Publication
(10) Pub. No.: US 2006/0271433 A1
(43) Pub. Date: Nov. 30, 2006

(54) Method and apparatus for providing a higher level of security and reliability in distributing treats to children

(76) Inventor: Michael L. Hughes, Los Angeles, CA (US)

Correspondence Address: MICHAEL L. HUGHES, 6714 SELMA AVE., LOS ANGELES, CA, 90028, US

(21) Appl. No.: 11/416,538

(22) Filed: May 3, 2006

Related U.S. Application Data
(60) Provisional application No. 60/676,803, filed on May 3, 2005.

(51) Int. Cl. G06Q 30/00; A63F 9/24

(52) U.S. Cl. 705/14; 463/16

(57) ABSTRACT

A system for providing a higher level of security and reliability in distributing treats to children, a method for producing promotional gaming ticket sets including taking sponsorship orders from multiple sponsors who pay promotional consideration for their product's exposure to be included on individual promotional gaming ticket formations contained within a set, where each set includes a plurality of gaming device tickets having a guaranteed win outcome, and a system to reduce post-holiday inventory at pre-holiday prices. The systems and methods include utilizing a promotional gaming ticket having a guaranteed win outcome comprising a substrate device, a plurality of play indicia affixed to the surface of the device, at least one identification code which distinguishes a winning outcome from a non-winning outcome, an outcome reward system wherein a winning outcome is always guaranteed and a promotional prize is always awarded; the promotional prize compromising a predetermined redeeming value that is reduced from the cost of a promotional object; where the value is a selected one of a predetermined amount of money, a predetermined percentage of money, and the full price of the promotional object, reward redemption instructions and a removable coating secured to the surface of the device over a selected one of the play indicia, redeeming value and the promotional object indicia.

### CROSS REFERENCE TO RELATED APPLICATION(S)

This application claims priority to U.S. Provisional Application No. 60/676,803 filed May, 03, 2005, the entire disclosure of which is herein incorporated by reference.

### BACKGROUND OF THE INVENTION

The present invention relates generally to the distribution of holiday treats and more specifically relates to the distribution of holiday treats to children. For the benefit of explanation, one embodiment of this invention would be used in distributing Halloween treats to children in a safe and reliable manner, however can also be used in distributing treats to other entities for other holiday and non-holiday purposes as well.

Halloween is a wonderful time of year for most children. They have the opportunity to dress up as their favorite hero or character, and solicit their friends, family, and neighbors for Halloween treats by walking up to their front door and saying Trick or Treat. The history of trick-or-treating can be traced back to the early celebrations of All Soul's Day in Britain. The poor would go begging and the housewives would give them special treats called soul cakes. This was called going a-souling, and the soulers would promise to say a prayer for the dead. Over time the custom changed and the town's children became the beggars. As they went from house to house they would be given apples, buns, and money.

As European immigrants came to America, they brought their varied Halloween customs with them. As the beliefs and customs of different European ethnic groups, as well as the American Indians, meshed, a distinctly American version of Halloween began to emerge. In the second half of the nineteenth century, America was flooded with new immigrants. These new immigrants, especially the millions of Irish fleeing Ireland's potato famine of 1846, helped to popularize the celebration of Halloween nationally. Taking from Irish and English traditions, Americans began to dress up in costumes and go house to house asking for food or money, a practice that eventually became today's “trick-or-treat” tradition.

Trick-or-treating was a relatively inexpensive way for an entire community to share the Halloween celebration. In theory, families could also prevent tricks being played on them by providing the neighborhood children with small treats. A new American tradition was born, and it has continued to grow. Today, Americans spend an estimated $6.9 billion annually on Halloween, making it the country's second largest commercial holiday.

As Halloween has quickly become the second most popular retail holiday in the United States (just behind Christmas), the holiday's popularity combined with a tradition that leaves our children vulnerable to receiving edible treats from strangers has inflated long-standing fears about the safety of our children.

An incident that brings life to these fears occurred in Minneapolis in 2000. James Joseph Smith (49) was charged with one count of adulterating a substance with intent to cause death, harm or illness after it was determined he'd put needles in Snickers bars and had been handing them out to children on Halloween. A 14-year-old boy was pricked by a needle hidden in a bar he'd bitten into, but fortunately only required minor medical attention.

It's been a long time since Trick-or-Treating was safe. For years, miscreants have been attempting to harm children with poisoned candy, razor blades, needles and more. Every year, the Poison Control Center receives numerous calls from parents concerned about the safety of candy children receive while trick or treating. Unfortunately, the only advice the Poison Control Center can offer is to suggest that parents, who often aren't aware of what to look for, inspect the treats to the best of their abilities before their children eat them. More recently, this, coupled with the holiday following on the heels of the anniversary of the September 11 attacks on the U.S., has left many parents extra fearful and suspicious of these indistinguishable attacks on their children as a form of terrorism against the United States.

In 2002, a Costco employee reported to the FBI that a gentleman of middle eastern descent opened up an account at the Hackensack, N.J. Costco and purchased close to $7,000 worth of candy. This same person purchased close to $15,000 worth of addition Candy 2 days before at the Wayne, N.J. Costco. The cashier became alarmed at this large purchase of candy and more so when the person paid cash.

Around the same time, 2 Arabic men bought more than $35,000.00 dollars worth of candy, in Wayne, N.J. $15,000.00 & in Hackensack, N.J. $20,0000.00. After they left, it was found that their Costco identification was fake, & they also paid for the candy with cash.

Whether these reports are substantiated or are altered versions of urban legends, their lasting effects on parents across the United States are real; most parents don't believe in ghosts and goblins anymore, but they do believe in criminals.

In recent years, shopping malls have become the safe alternative to trick or treating to strangers with kids going store-to-store for candy from employees. Unfortunately, due to the finite number of stores in a given shopping mall, this process is less exciting and somewhat limiting to children who want to maximize their trick or treating activities. In addition, such a process of having children dress in their favorite costumes to go to a shopping mall compromises the dated tradition of trick or treating.

Currently, there is a need for children to experience Halloween trick-or-treating in the traditional manner, while providing a higher level of security and reliability in the manner they receive Halloween treats.

### BRIEF DESCRIPTION OF THE DRAWINGS

This invention may be embodied in the form illustrated in the accompanying drawings, attention being called to the fact, however, that the drawings are illustrative only, and that changes may be made in the specific construction illustrated.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a plan front view of a safety certificate which emphasizes a specific size treat, but allows the user to have a choice of treats;

FIG. 2 is a plan front view of a safety certificate which emphasizes a specific treat name;

FIG. 3 is a plan front view of a safety certificate which emphasizes a particular manufacturer of treats;

FIG. 4 is a plan front view of a safety certificate which emphasizes a treat entry, which can be used as a chance to win a larger treat;

FIG. 5 is a plan rear view of a safety certificate which emphasizes a barcode for tracking and validation purposes, an expiration date, and a request for personal information;

FIG. 6 is a plan front view of a safety certificate which emphasizes a particular monetary discount off holiday treats, which can be combined for larger purchases and a licensed character about the surface of the certificate;

FIG. 7 is a plan front view of a safety certificate which emphasizes an alpha-numeric sequence and a value concealed with scratch-off matter or removable coating;

FIG. 8 is a plan front view of a promotional gaming ticket which contains concealed play indicia and a removable coating secured to the surface of the certificate over the redeeming value and the predetermined award;

FIG. 9 is a plan front view of a token which can replace the likes of all certificates mentioned above;

FIG. 10 is a plan front view of the certificate booklet which contains a plurality of certificates;

FIG. 11 is a schematic block diagram of the system and method of the present invention.

FIG. 12 is a schematic block diagram of a fundraising system and method for raising funds through marketing the safety certificates, according to an embodiment of the present invention.

FIG. 13 is a schematic block diagram of an online fundraising system and method for raising funds through marketing the safety certificates, according to an embodiment of the present invention.

FIG. 14 is a schematic block diagram of a method for a distributor of holiday goods to reduce post-holiday inventory at pre-holiday prices while enticing new local patrons to visit their store.

### DETAILED DESCRIPTION OF THE INVENTION

Turning now descriptively to the drawings, in which similar reference characters denote similar elements throughout several views, the attached figures illustrate various embodiments of a system and method to distributing Holiday treats that allows children to experience Halloween trick-or-treating in the traditional manner, while providing a higher level of security and reliability in the manner that they receive holiday treats.

In this respect, before explaining at least one embodiment of the invention in detail, it is to be understood that the invention is not limited in its application to the details of the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

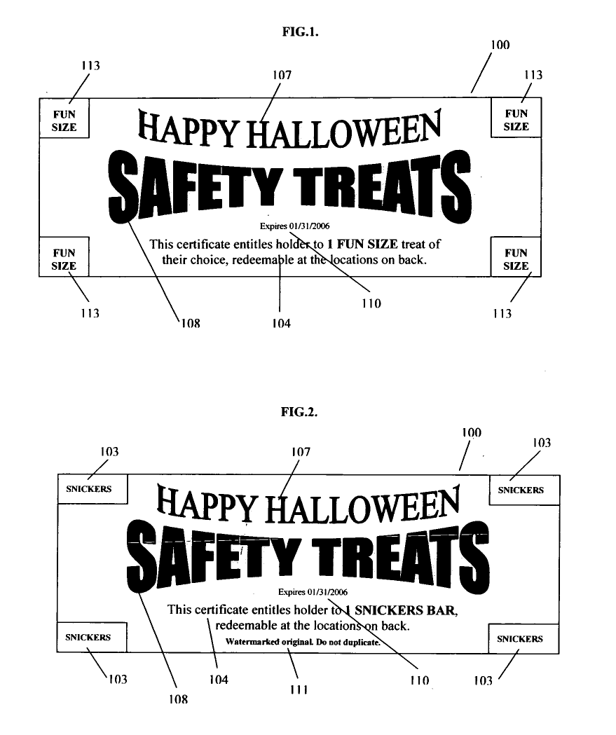

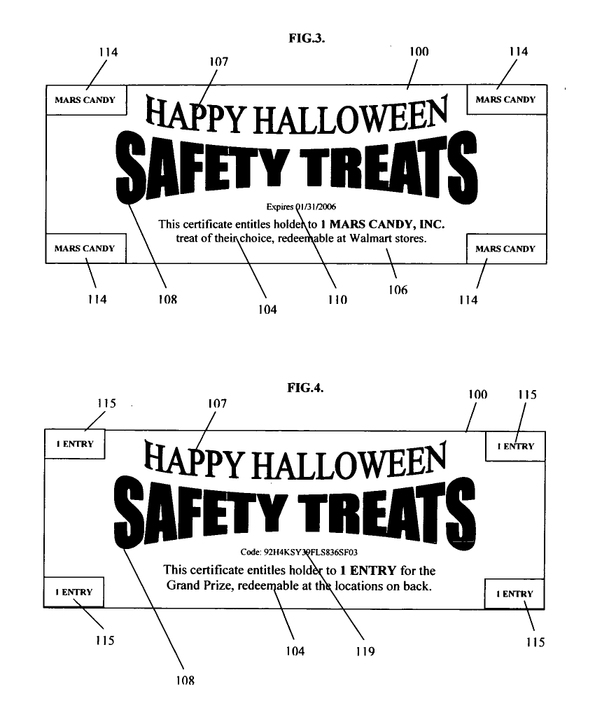

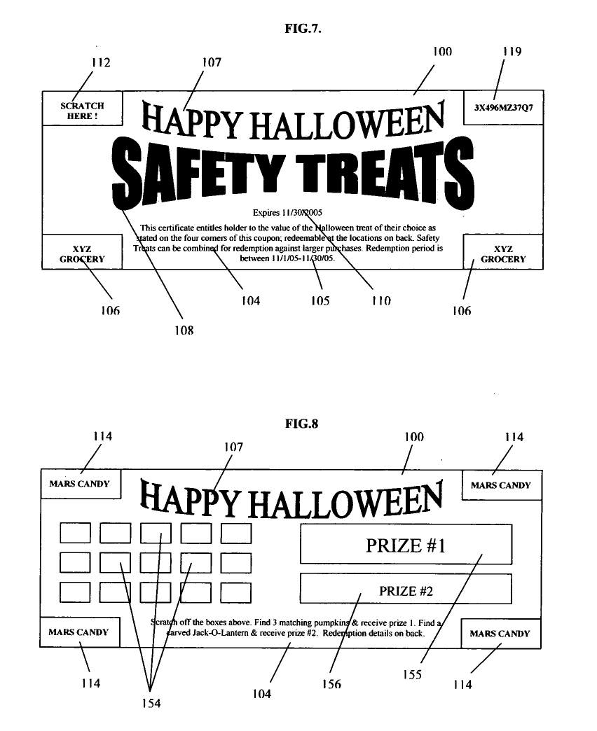

FIGS. 1-10. In one embodiment of the present invention, a safety certificate 100 is introduced for the purpose of distribution of treats to children in a safe and reliable manner, such as on Halloween; but can also be used on other occasions, such as birthdays, Christmas, Hanukah, Valentine's day, Easter, and in one embodiment can also be distributed year round in non-holiday situations. The certificate 100 is comprised of a certificate 100, ticket, voucher, token 101 as in FIG. 9, coupon, coin, or computer readable storage medium 160 as in FIG. 5, entitling a recipient or other entity bearing the certificate 100 to receive a prize or award, which is always awarded. In one embodiment, the prize or award consists of a predetermined redeeming value that is reduced from the cost of a predetermined object. The redeeming value is a predetermined amount of money 102, a predetermined percentage of money such as 50% off, or the full price of the predetermined object.

In one embodiment, multiple redeemable certificates can be combined and redeemed together against a single higher valued object. In one embodiment the description, such as the name of predetermined object 103, size of predetermined object 113, selection of predetermined objects of a certain manufacturer 114, services, or other preferential treatment or consideration, or a combination thereof is stated on the certificate 100.

The certificate 100 is manufactured of paper, card or cover stock, plastic, fabric, metal, wood, electronic matter, chemical matter, organic matter, or other similar printable or mark-able material; and is typically rectangular in shape but may take other shapes or forms, where such certificate 100 may be printed or otherwise marked with instructions for redemption 104, certificate redemption value 102, redemption site 106 or similar identification, some specific or relative value for which the certificate is valid, name or title of the certificate 108, at least one bar code 109 or other tracking means, possible applications, limitations, restrictions, expiration dates 110 and may include security features 111 to thwart off unauthorized duplication.

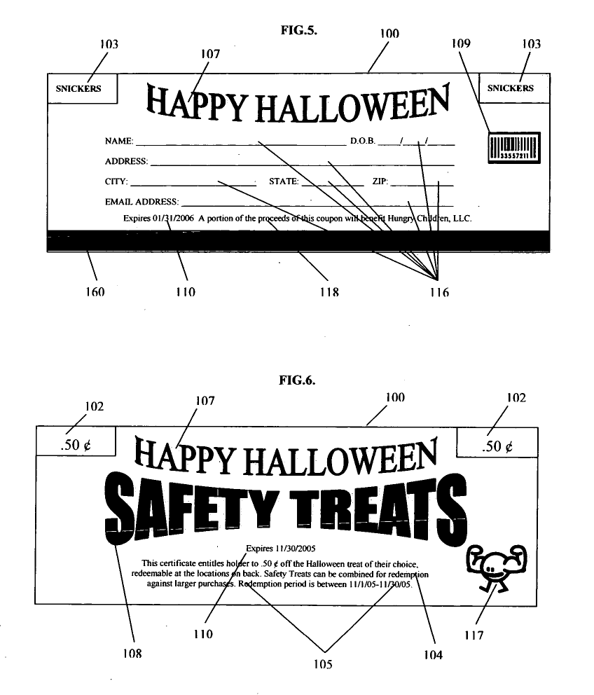

FIG. 4. In one embodiment, the safety certificate can be used as a treat entry 115 for the holder to enter into a contest, raffle, or sweepstakes to win a larger treat or prize. In one embodiment, the safety certificate contains an identifying code 119 such as a barcode or alpha numeric code, where the identifying code is pre-determined to be the winning code of an award. In one embodiment, the safety certificate contains an identifying code 119, where the identifying code is pre-determined to not be the winning code of an award. In one embodiment, the gaming tickets contain non-electronic, educational material or entertainment such as tattoos, scratch and sniff matter and stickers.

FIG. 5. In one embodiment, the safety certificate has a request for personal information 116 about the certificate, such as name, address, date of birth, text messaging information, electronic contact information, email address, etc, so the treat manufacturer treat distributor, certificate manufacturer or certificate sponsor can keep in touch with the certificate recipients for future promotional purposes. In one embodiment, the name and/or logo of a charity 118, non-profit organization, cause, or school who would receive a portion of the certificate's proceeds would be displayed about the certificate. In one embodiment, the certificate contains trivia and a holiday message 107.

FIG. 6. In one embodiment, characters 117, logos or artwork familiar to children, such as popular cartoon and movie characters 117 would be placed about the certificates for recognition and promotional purposes, according to the licensing guidelines of each perspective character licensor. In one embodiment, the certificates would contain non-merchandise, promotional material from a sponsoring 3^{rd} party, promoting the 3^{rd} party's goods or services, such as a new movie coming to theatres.

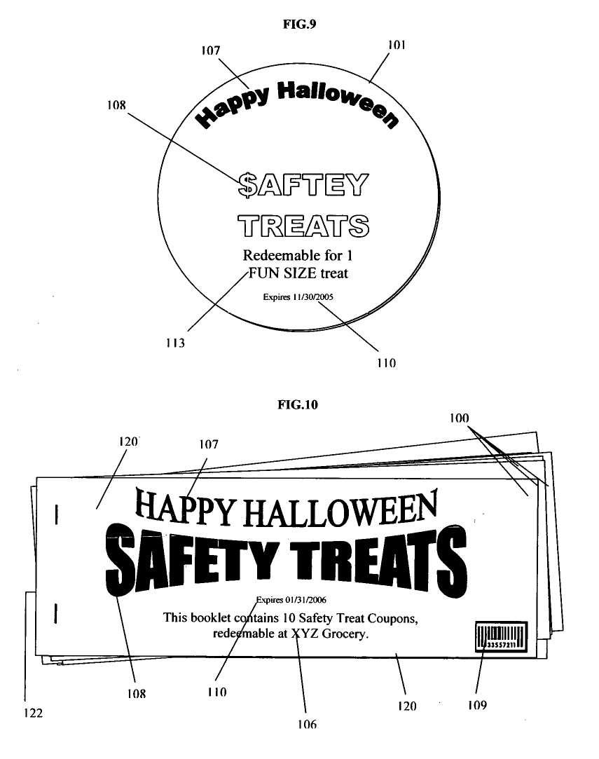

FIG. 7. In one embodiment, the safety certificate contains a numeric, alphabetical, or alpha-numeric sequence 119, which when inserted about an internet portal, cell phone, PDA, or computer program, brings about a form of value. In one embodiment, the value is at least one unit of downloadable or non-downloadable music or video, downloadable telephone ring-tone, non-downloadable online gaming, or similar downloadable or non-downloadable entertainment. In one embodiment, a combination of at least two of the aforementioned embodiments would provide the recipients with options to choose from. In one embodiment, the redeeming entity can program a website to identify a particular product, service or offer, such as particular post-holiday items remaining in inventory as the redeeming object. In one embodiment, a recipient would provide personal data to redeem the award. In one embodiment, a recipient would not have to provide personal data to redeem the award.

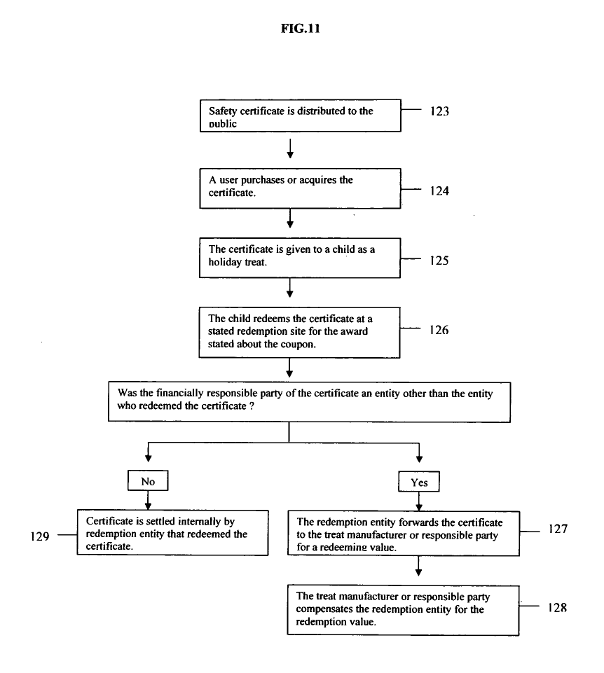

FIG. 8 is a plan front view of the safety certificate in one embodiment, which is a promotional gaming ticket having an instant, guaranteed win outcome comprising a substrate device, a plurality of play indicia 154 affixed to the surface of the device, which can be game indicia, symbols or a combination of indicia and symbols thereof; at least one identification code which distinguishes a winning outcome from a non-winning outcome, and an outcome reward system wherein a winning outcome is always guaranteed and an award or prize 155 is always awarded. In one embodiment, the play indicia 154 affixed to the surface of the card corresponds with a themed holiday.

In one embodiment, the award or promotional prize includes a predetermined redeeming value that is reduced from the cost of a promotional object. The value is a selected one of a predetermined amount of money, a predetermined percentage of money, and the full price of the promotional object. In one embodiment, the redeeming value is predetermined, but the redeeming promotional object is not. In one embodiment, the redeeming object is predetermined, but the redeeming value is not.

In one embodiment, the gaming ticket contains play indicia 154 and a removable coating 112 secured to the surface of the certificate over the play indicia 154, redeeming value and the predetermined object. In one embodiment, the gaming ticket contains other removable coating or other methods of concealment, such as pull tabs, covering game indicia 154 or the predetermined values or objects 155 the certificate is valid or redeemable for.

In one embodiment, several high-valued prize giveaways 156 (ex: Xbox 360, video iPod, concert tickets, events, backstage passes, or a trip to Disney Land) are randomly offered as the prize on the gaming tickets and are concealed within booklets or sets along with gaming tickets or certificates containing standard product giveaways mentioned above to generate a higher demand and perceived value of the gaming tickets in the target market.

In one embodiment, the gaming tickets contain game indicia 154 to offer the chance for a recipient to receive a larger prize, for example, a recipient would scratch off or remove concealment on a series of boxes. If one of the numbers matched a pre-determined number, the recipient would receive a larger award 156; if the numbers didn't match, they would receive a smaller award 155, or if removing a removable coating revealed 3 pumpkins, the recipient would receive the larger award 156, if it only revealed 1 or 2 pumpkins, the recipient would receive the smaller award 155. In one embodiment, a recipient could receive a combination of both the larger 156 and smaller 155 award.

In one embodiment, a recipient can log onto a website & activate an online certificate, where they can virtually remove concealing matter with a peripheral device to reveal a prize; the prize being an award that can be printed and redeemed locally or redeemed online. In one embodiment, at least one ticket per person or household would be available at no cost to recipients through mailing in a postcard, logging onto a website, or other non-paying means as an additional method of participating and to comply with state and national sweepstakes laws where applicable.

In one embodiment, a plurality of gaming tickets are distributed in a set or booklet containing a theme, such as for Halloween, and each ticket within the booklet is designed to encompass the theme. For example, a booklet called “The Great Halloween Scratch-off!” could contain 10 scratch-off tickets, each having Halloween themes and names as follows; Zombie Scratch, Haunted Giveaway, Black Cat Scratch, Scarecrow Scratch, Pumpkin Patch Freebee Scratch, Jack-O-Scratch, Franken-Scratch, Ghost & Goblin Giveaway, Spider Scratch, Which Witch will Scratch which Scratch. In one embodiment, a combination of game indicia, prize, coupon, promotion or a giveaway would be on the gaming ticket. In one embodiment, if the recipient didn't win the game prize, they would still receive the benefit of the coupon, promotion or giveaway.

In one embodiment, the gaming tickets contain games or educational matter, such as math scratch, history scratch, spelling scratch, or trivia scratch to add entertainment or educational value. In one embodiment, recipients are interactively tested in trivia, whereby inserting a code from the certificate into a website activates a trivia game. In one embodiment, a removable coating printed with trivia answers conceals additional codes; removing the coating printed with the proper answer reveals said code which brings about a value when inserted into a website or phone device. In one embodiment, inserting a code into the website or phone device which was concealed under an incorrect answer ends the trivia game.

In one embodiment, multiple gaming tickets are combined by a recipient in a single game of skill or chance, such as a treasure or scavenger hunt. In one embodiment, the gaming tickets contain a coupon value to be applied towards the purchase of goods or services. In one embodiment, the gaming tickets are not holiday specific, and are distributed year round, including non-holidays.

Size, shape, materials, and construction are not critical to the usefulness of the certificate 100, and are not limiting factors in the definition or usefulness of the certificate 100. In the context of this invention description, the terms “certificate” and “gaming ticket” are intended to be general and all-inclusive within the parameters stated above and defining its purpose and use.

FIG. 10. The safety certificates 100 can be distributed in other forms, including but not limited to being coupled together as a set or booklet 120 comprising: a front cover 121 and back cover having a common edge 122; a number of certificates 100 each coupled to the common edge 122; at least one bar code 109 or means of identifying the booklet; wherein front and back covers and the certificates 100 are coupled to a common edge 122 such that front cover 121, back cover, and certificates 100 are open-able and closable in a book-like manner. In one embodiment, the certificates are coupling without a front and back cover and are connected and perforated on the north and south sides or east and west sides of the certificate in a lottery ticket fashion. In one embodiment, certificates are sold individually.

It is also within the present invention to color-code, or differentiate the booklets. For example, booklets containing different numbers of certificates, different features, or with certificates 100 of different values may be color coded with different colored prominent headings or borders, or otherwise differentiated. It is appreciated that color-coding or other methods of differentiation advantageously assists the distributor and consumer to quickly differentiate between the booklet differences.

In one embodiment, the booklets and certificates are designed in other languages to cater to specialty or minority markets, or are themed towards boys, girls, age groups, or special interest groups. In one embodiment, the values or prizes offered on the certificates are coordinated with the theme of the booklet or certificate. In one embodiment, the play indicia located on the certificates is coordinated with the theme of the booklet or certificate.

In one embodiment, the booklets also contain coupons or promotional materials targeted towards the entities, such as mothers or wives, who purchase or acquire the booklets of certificates to distribute. In one embodiment, consideration is paid by a sponsoring company for including the coupons or promotional materials in the booklets, which helps to defray costs associated with the manufacturing, promotion, distribution or redemption of the certificates.

FIG. 11. One embodiment of the present invention provides an improved method or process of distributing Halloween treats to children that allows children to experience Halloween trick-or-treating in the traditional manner, while providing a higher level of security and reliability in the manner that they receive the Halloween treats, where the safety certificate booklets 120 are distributed 123 through at least one product manufacturer, retail store, grocery store, mass merchant, membership store, food establishment, convenience store, 3^{rd} party distributor, downloadable or non-downloadable entertainment company, school, student, charitable or non-profit entity, religious organization, 501(c) corporation, and the likes thereof; and are purchased 124, given along with a purchase, given for free, or otherwise acquired by customers for the purpose of giving them as a gift of a Halloween treat to children during the Halloween holiday.

In one embodiment, the safety certificate booklets 120 are purchased 124 or acquired through a website, internet portal, internet company, vending machine, or other electronic source, and are delivered directly, through mail, downloaded or received electronically by customers to print or otherwise distribute as previously described.

After a customer purchases 124 or acquires the safety certificate booklet 120, they give 125 at least one of the certificates 100 of the booklet 120 to children as a Halloween treat while trick-or-treating, holiday parties at their school, or through other holiday or non-holiday gift-giving situations. In one embodiment, the redeeming value is concealed, where the recipient first removes the concealment to identify the prize or redeeming value.

With a safety certificate 100 in hand, typically within a certain time period after the holiday has passed, such as 30, 60, or 90 days, the children take the certificate 100 to the redemption location 106 as specified on the safety certificate 100, such as the local treat distributor, retail store, grocery store, treat manufacturer, convenience store, website or a combination thereof, and redeems 126 the certificate 100 for the prize specified about the certificate 100; to receive the pre-determined value, for example “cents off” 102 a holiday treat, directly from such location 106.

In one embodiment, the certificate recipients would redeem 126 the certificate 100 directly through the mail, through the internet or through other non-personal means.

After the redemption 126 of the certificate 100, if the origin, sponsoring entity or financially responsible party of the certificate redemption cost was an entity other than the entity who redeemed the certificate, such as the certificate or treat manufacturer, then the entity who redeemed the certificate may deliver 127 the redeemed certificate to their redemption agent, redemption facility, or clearinghouse; where valid certificates are identified, and delivered to the financially responsible party, who compensates 128 the entity who redeemed the certificate 100 for the discount, cost of goods, or other similar value. Alternatively, if the origin or financially responsible party of the certificate 100 was the entity who redeemed the certificate 100, the certificate 100 is settled 129 internally by the entity that redeemed the certificate 100.

In one embodiment, the redeemable safety certificate is distributed by a product manufacturer, distributor or 3^{rd} party at no charge to consumers, whereby the certificate manufacturing cost and recipient redemption cost is absorbed by a sponsor or multiple sponsors, such as a product manufacturer as a promotional tool. For example, a downloadable entertainment company may provide booklets of holiday certificates, to be given out at Halloween at no cost, which allow it's recipients to download one free music file from the company's website, and the cost of the download is incurred by the entertainment company as a means to generate awareness and new customers to their goods, services or website.

In one embodiment, the booklets or sets are comprised of a plurality of individual gaming ticket formations, with one or multiple sponsors' promotional products as the prize or predetermined objects on a plurality of the tickets as a way to promote products of participating sponsors who pay promotional consideration for product exposure. In one embodiment, the sponsor or sponsors pay a sponsorship fee based on booklet distribution numbers, a flat promotional fee (for example, $100,000 per certificate in a booklet), a revenue share of consideration generated from the distribution of the free giveaway, a percentage or the whole redemption cost of the promotional product, or a combination thereof as promotional consideration for their product exposure. In one embodiment, a percentage of the consideration paid by a sponsor is held in escrow to be applied against the cost of the prize redemption expense until after the redemption period has passed.

In one embodiment, promotional gaming ticket sets are manufactured by taking sponsorship orders from multiple sponsors who pay promotional consideration for their product's exposure to be included on individual promotional gaming ticket formations contained within a set, with multiple sponsors promotional products as the prize item or predetermined object on individual tickets which vary from ticket to ticket with different promotional products from different sponsors, so as to provide promotional products from a plurality of different sponsors at frequencies that vary between sponsors.

In one embodiment, the certificates are manufactured or distributed by a 3^{rd} party to customers for a fee whereby the 3^{rd} party retains the fee for promotional and distribution efforts, but the certificate redemption cost is absorbed by the sponsor whose offer is located about the certificate as the promotional cost for a means to generate awareness and new customers to their goods, services or website.

In one embodiment, the revenue generated by the distribution of the safety certificates is shared with either the distributor, a sponsor, a redeeming entity, a nonprofit entity, or the certificate manufacturer. In one embodiment, both the consideration generated from the distribution of the safety certificates and the expense incurred in the redemption of the safety certificates are shared with a distributor, a sponsor, a redeeming entity, a nonprofit entity, or the safety certificate manufacturer.

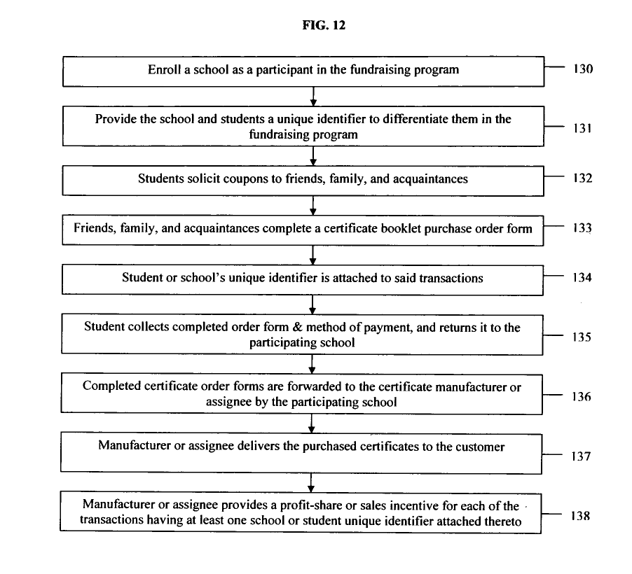

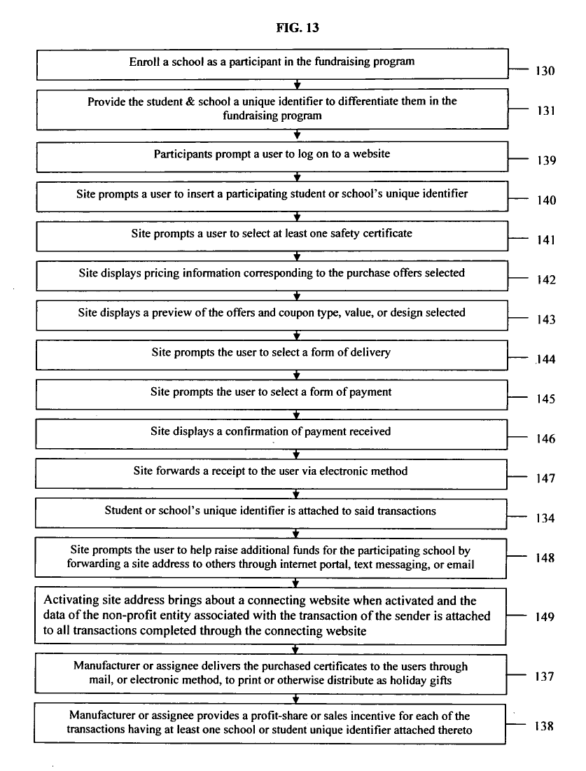

FIG. 12. One embodiment of the present invention is a method for participating schools, non-profit organizations, and the likes thereof to distribute the certificates as a fundraising tool, consisting of (a) enrolling 130 a plurality of schools as participants in a charitable program (b) providing 131 the participant schools and students a unique identifier to differentiate each school and student participating in the fundraising program (c) attaching 134 at least one unique identifier to transactions occurring through participating students and schools (d) providing 138 a profit-share or sales incentive for each of the transactions having at least one school or student designator attached thereto.

Once participating schools are enrolled in the fundraising program 130, students of participating schools, or the likes thereof, solicit 132 the safety certificate booklets to their family, friends, and acquaintances. Family, friends, and acquaintances complete 133 a certificate booklet order form, and the student collects 135 a completed sales order form and a method of payment, and return them to their school, attaching 134 at least one student unique identifier to each transaction. The participating school then forwards 136 the order form to the certificate manufacturer or responsible company, who delivers 137 the safety certificate booklet directly to the customer, and provides 138 a sales incentive or share of the revenues from the associated transactions to the participating schools.

FIG. 13. In one embodiment, students and participating schools are provided 131 with a unique identifier, such as an identification number. Students promote the fundraising program through prompting 139 family, friends, acquaintances, and potential supporters to log onto a participating website or internet portal. The website prompts 140 a user to input the student's and/or school's unique identifier.

In one embodiment, the website or internet portal contains a unique identifier search for when the user has the name of the student, but doesn't have the unique identifier. In one embodiment, when the user enters the student's unique identifier, a webpage appears with the student's name and the name of the associated school. In one embodiment, the page displays the amount of sold certificates credited to the particular student, the highest number of sold certificates credited to a single student, or top 10 students, in the particular student's school or area, or the total number of sold certificates credited to the particular student's school.

A user is prompted 141 to select at least one safety certificate booklet. In one embodiment, the site offers the user a variety of booklets to choose from, each containing various certificate offers, various amounts of certificates, or various designs. The site displays 142 associated pricing information corresponding to the certificate order. Once the user indicates their intent to complete the transaction and checkout, the site displays 143 a preview of the order and associated cost is shown. In one embodiment, the site prompts 144 the user to select a form of delivery and costs associated with expedited shipping. The site prompts 145 the user to select a form of payment, and once received and confirmed, the site displays 146 a confirmation of payment page, and a receipt is sent 147 to the user via email or other electronic means. The selected certificates are then delivered 137 to the user by the certificate manufacturer or pre-determined responsible party, and the manufacturer or assignee provides 138 a sales incentive or share of the revenues from the associated transactions to the participating schools.

In one embodiment, users are prompted 148 to help raise additional funds for the participating cause, non-profit, charity or school by sending an electronic communication containing a website address to family, friends, acquaintances, and potential supporters through an internet portal, email, text messaging, podcast or other electronic way. The website address is connected to a server, and activating 149 the website address brings about an internet website containing identifying data of the non-profit entity selected by the sender; a transaction on the internet website by the recipient generates a revenue-share for the associated non-profit entity.

After confirming the transactions, manufacturer, sponsor or assignee provides 138 a profit-share or sales incentive for each of the transactions having at least one school or student identifier attached hereto. In one embodiment, manufacturer, sponsor or assignee delivers a prize to the participating schools and students based on their performance levels.

In one embodiment, both the students and schools can access a database where an accounting of their credited transactions are viewable through inputting their unique identifiers and passwords. In one embodiment, customer's data is saved in a database and customer's are added to a mailing list to receive new offers periodically. Customers who purchase future offerings, will have the option to continue to be associated with the school and student that benefited from their initial purchase, where the associated school continues to receive a sales incentive or profit-share.

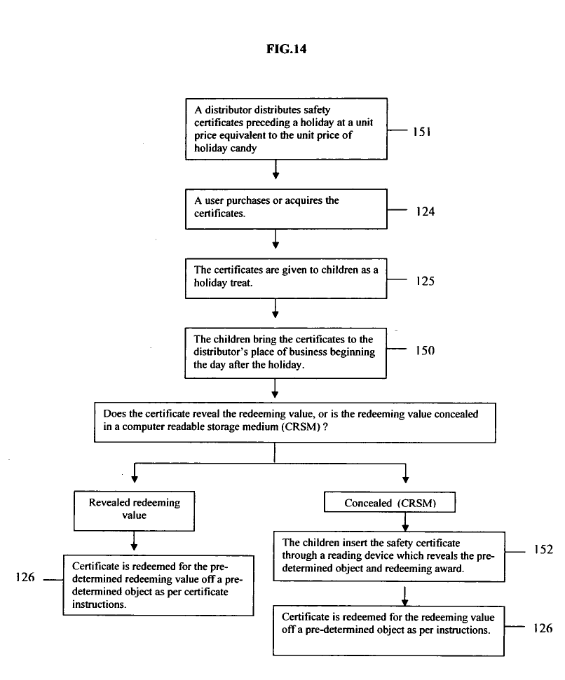

FIG. 14. One embodiment of the present invention is a system for a distributor of holiday goods to reduce post-holiday inventory at pre-holiday prices while enticing new local patrons to visit their store, where the distributor distributes 151 safety certificates preceding a holiday at a cost similar to the equivalent cost of holiday candy (for example, if a bag of 10 units of Halloween candy is sold for $2.99, a booklet of 10 safety certificates might be sold for $2.99). This is particularly helpful for distributors who are left with millions of dollars of perishable holiday inventory, such as candy, after the holiday is over, who are forced to sell it at drastically reduced prices.

In the present embodiment, the certificates are sold along with other holiday items in the weeks before the holiday, however are not redeemable 126 until at least the day following the holiday, as the purpose of the safety certificates is to be given away on the particular holiday. In the present embodiment, the post-holiday inventory is the redeeming award, and the distributor's place of business is the redemption site.

In one embodiment, the safety certificate contains a computer readable storage medium 160. The recipient brings 150 the safety certificate to the distributor's place of business to insert 152 the certificate in, on, through or near a reading device which reveals the pre-determined object, and the redemption value, which is then redeemed by the recipient 126. In one embodiment, a redeeming recipient will receive a printout identifying the redeeming value after inserting the certificate in the reading device. In one embodiment, the reading device permanently collects the safety certificate and outputs an identifying printed award, identifying the object, value and instructions for redemption. In one embodiment, the distributor can program the reading device to identify a particular product, such as particular items remaining in the post-holiday inventory as the redeeming object.

It should be understood that, while the invention is described herein in terms of certificates and gaming tickets distributed on the Halloween holiday, the invention is applicable to other types of goods or services sold at other facilities, including but not limited to software, downloadable and non-downloadable entertainment, balloons, candy, chocolate, gum, holiday games, movie rentals, food, and drink, all children's products and services; and can be used on all holidays, anniversaries, and birthdays; and all gift giving situations to recipients of all ages, including teenagers, adults and senior citizens, and that certificates may be replaced by tokens, certificates, coins, gift cards, vouchers, computer readable storage devices, compact discs, electronic mailings, printouts and the like.

Therefore, the foregoing is considered as illustrative only of the principles of the invention. Further, since numerous modifications and changes will readily occur to those skilled in the art, it is not desired to limit the invention to the exact operation shown and described, and accordingly, all suitable modifications and equivalents may be resorted to, falling within the scope of the invention. It will be appreciated that not every implementation will necessarily embody all or even most of the specific embodiments, details and extensions discussed above in relation to the basic system. However, the system is described in the above manner to reduce the need for external reference when attempting to understand the context in which the alternative embodiments and aspects of the present invention operate.

Should any provision of this patent be void or unenforceable for any reason, such provision shall be deemed omitted and this patent with such provision omitted shall remain in full force and effect.

What is claimed is:

1. (canceled)

2. (canceled)

3. (canceled)

4. (canceled)

5. (canceled)

6. (canceled)

7. A promotional gaming ticket having a guaranteed possible win outcome comprising;
a substrate device,
a plurality of play indicia affixed to the surface of the device,
at least one identification code which distinguishes a winning outcome from a non-winning outcome,
an outcome reward system wherein,
a winning outcome is always possible and a promotional prize is always awarded for a winning game outcome,
the promotional prize compromising:
a predetermined redeeming value that is reduced from the cost of a promotional object; where the value is a selected one of a predetermined amount of money, a predetermined percentage of money, and the full price of the promotional object,
a removable coating secured to the surface of the device over a selected one of the play indicia, redeeming value and the promotional object indicia.

8. The promotional gaming ticket of claim 7, wherein multiple tickets can be combined and redeemed together against a single, higher valued promotional object.

9. The promotional gaming ticket of claim 7, comprising;
a plurality of individual gaming ticket formations in a set providing promotional products as the promotional objects on a plurality of the tickets to promote products of participating sponsors who pay promotional consideration for product exposure, wherein;
the promotional objects on the tickets contained in the set being different from other promotional objects on the tickets of the same set so as to provide promotional products for a plurality of different participating sponsors which may vary between ticket formations of the set.

10. A method for producing promotional gaming ticket sets comprising:
(a) taking sponsorship orders from multiple sponsors who pay promotional consideration for their product's exposure to be included on individual promotional gaming ticket formations contained within a set, wherein each set includes a plurality of gaming device tickets having a guaranteed possible win outcome, each ticket comprising;
a substrate device, a plurality of play indicia affixed to the surface of the device, at least one identification code which distinguishes a winning outcome from a non-winning outcome, an outcome reward system wherein a winning outcome is always possible and a promotional prize is always awarded for a winning game outcome, the promotional prize compromising: a predetermined redeeming value that is reduced from the cost of a promotional object; where the value is a selected one of a predetermined amount of money, a predetermined percentage of money, and the full price of the promotional object, and a removable coating secured to the surface of the device over a selected one of the play indicia, redeeming value and the promotional object indicia.
(b) producing the set containing a plurality of individual gaming ticket formations with multiple sponsors promotional products as the promotional object on individual tickets which vary from ticket to ticket with different promotional products from different sponsors, so as to provide promotional products from a plurality of different sponsors at frequencies that vary between sponsors.

11. The method of claim 10 wherein a sponsor's promotional consideration paid for exposure received in the promotional gaming ticket sets consists of a selected one of a percentage of the cost of the predetermined redeeming value, a promotional fee, a sponsorship fee, and a share of revenue generated from the distribution of the promotional gaming ticket sets.

12. The method of claim 11 wherein a percentage of the sponsor's promotional consideration is held in escrow to be applied against a percentage of the cost of the predetermined redeeming value, the remaining balance is released to a selected one of the ticket set distributor, a ticket redeeming entity, a non-profit entity, and the ticket manufacturer after a period of time.

13. The method of claim 10 wherein a selected one of the revenue generated from the distribution of the promotional gaming ticket sets and the cost of the predetermined redeeming values of the promotional gaming ticket sets are shared with a selected one of the ticket set distributor, a ticket redeeming entity, a sponsor of the promotional object, a non-profit entity, and the ticket manufacturer.

14. A system for distributing items to children in a secure and reliable manner, comprising:
(a) distributing a plurality of ticket formations by a distributor, the individual ticket formations providing a selected one of a guaranteed redemption value and a game where a winning outcome is always possible and a promotional prize is always awarded for a winning game outcome, comprising: a removable coating secured to the surface of the ticket formation and at least one value part which indicates a redemption value associated with the ticket formation; the redemption value compromising:
a predetermined value that is reduced from the cost of a promotional object; where the value is a selected one of a predetermined amount of money, a predetermined percentage of money, and the full price of the promotional object;
(b) acquiring the ticket formation by an entity through a selected one of purchasing the ticket formation, receiving the ticket formation along with a purchase, receiving the ticket formation for free;
(c) giving the ticket formation by the entity to a child recipient as a gift;
(d) removing the removable coating by the child recipient to win a game and reveal a selected one of the redemption value and the promotional object indicia;
(e) redeeming the ticket formation by the child recipient for the redemption value associated with the ticket formation.

15. The individual ticket formation of claim 14, wherein a plurality of ticket formations can be combined and redeemed together against a single, higher valued object.

16. The system of claim 14 wherein the distributor is a selected one of a retail store, grocery store, outlet store, wholesale store, drug store, mass merchant, membership store, vending machine, product manufacturer, student, charity, school fundraiser, 501(c) corporation, non-profit entity, religious organization, and internet website.

17. The system of claim 14 wherein the individual ticket formation is manufactured of a selected one of paper, plastic, cotton, mark-able material, synthetic material, fabric, chemical, coin, compact disc and computer readable storage medium.

18. The system of claim 14 wherein the individual ticket formation is a substrate device containing a selected one of a plurality of play indicia affixed to the surface of the device, at least one identification code which distinguishes a winning outcome from a non-winning outcome of the play indicia, a promotional prize indicia, redemption instructions, barcode, alpha-numeric code, expiration date, request for personal information, security feature, redemption value, predetermined object description, removable coating, artwork, trivia, tattoo, sticker, symbols, computer readable entertainment, non-computer readable entertainment, educational material, logo, entry, and holiday message.

19. The system of claim 14 wherein the individual ticket formation is redeemed at a selected one of retail store, grocery store, outlet store, sponsor's business, wholesale store, drug store, mass merchant, membership store, product manufacturer, food establishment, entertainment establishment internet portal and internet website.

20. The system of claim 14 wherein a plurality of ticket formations are purchased in a set through an internet website, a user is prompted to select a non-profit entity from a database, the non-profit entity associated to the selection will participate in a revenue share of the transaction; the non-profit entity is a selected one of a school, organization, foundation, non-profit entity, religious group, trust, student unique identifier, and 501(c) corporation.

21. The system of claim 20 wherein the user is prompted to send an electronic communication through a server to others containing a website address, activating the website address brings about an internet website containing identifying data of the non-profit entity selected by the sender, a transaction on the internet website by a recipient generates a revenue-share for the associated non-profit entity.

22. The system of claim 20 wherein a non-profit entity can track revenue-share activity on an internet website through the use of a predetermined unique identifier and password.

23. A system to liquidate post-holiday inventory at pre-holiday prices, comprising;
(a) distributing a plurality of ticket formations preceding a holiday for a fee by a distributor, the individual ticket formations providing a selected one of a guaranteed possible redemption value and a game where a winning outcome is always possible and a promotional prize is always awarded for a winning game outcome, comprising: a removable coating secured to the surface of the ticket formation and at least one value part which indicates a redemption value associated with the ticket formation; the redemption value compromising:
a predetermined value that is reduced from the cost of a promotional object;
where the value is a selected one of a predetermined amount of money, a predetermined percentage of money, and the full price of the promotional object, the post-holiday inventory is the promotional object;
(b) purchasing the ticket formation by an entity preceding a holiday;
(c) giving the ticket formation by the entity to a recipient as a gift;
(d) removing the removable coating by the recipient to reveal a selected one of a game outcome, the redemption value and the promotional object indicia;
(e) redeeming the ticket formation by the recipient for the redemption value associated with the ticket formation at the distributor's place of business, the ticket formation is not redeemable until at least the day following the holiday.

24. The individual ticket formation of claim 23, wherein a plurality of ticket formations can be combined and redeemed together against a single, higher valued object.

25. The system of claim 23 wherein the ticket formation contains a computer readable storage medium, the recipient brings the ticket formation to the distributor's place of business to insert through a reading device which identifies the promotional object and redeeming value.

26. The system of claim 23 wherein the distributor can program the reading device to reveal a particular product as the promotional object.
